(19) United States
(12) Patent Application Publication
(10) Pub. No.: US 2006/0101680 A1
(43) Pub. Date: May 18, 2006

(54) Container contents identifier

(76) Inventor: Michael J. Smith, Orangeburg, NY (US)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/140,134

(22) Filed: May 27, 2005

Related U.S. Application Data
(60) Provisional application No. 60/575,187, filed on May 28, 2004.

(51) Int. Cl. G09F 3/00

(52) U.S. Cl. 40/324

(57) ABSTRACT

A coaster or sleeve identifies the type of beverage within a container and also timely advertises a credit card prior to its use.

### CROSS REFERENCE TO RELATED APPLICATION

This application claims the priority of U.S. Provisional Patent Application No. 60/575,187, filed May 28, 2004.

### BACKGROUND OF THE INVENTION

1. Field of the Invention

The present invention generally relates to an identifier for identifying the contents of a container, especially a beverage cup.

2. Description of the Related Art

A coaster is a small mat or plate placed under a container to protect a tabletop or like surface beneath. As a dining accessory, a coaster is often positioned underneath a plate, dish, bowl, serving tray, beverage cup and like container to act as a thermal barrier between the contents of the container and the tabletop to prevent the latter from being exposed to excessive heat and cold. The coaster also serves as a mechanical protector to prevent the tabletop from being scratched when the container is moved along the tabletop. Especially in the case of containers filled with a fluid substance, the coaster often serves to sop up any fluid substance spilled from the containers. Sometimes, the coaster serves a decorative purpose and is placed under a container or other item mostly for ornamentation.

The coaster need not be placed directly on the tabletop. Often, a coaster is placed between a beverage cup and a saucer not only to absorb spilled beverage, but also to serve as a doily. Spillage is especially encountered in a restaurant where a hurried server often spills a beverage, such as coffee or tea, from the beverage cup into the saucer before the cup even reaches the diner.

A problem associated with serving coffee, tea and like beverages in cups and saucers is that there are many varieties of beverages that one can order. Tea can be caffeinated or not, or herbal or not. Coffee can be ordered to be made from hundreds of different beans from various countries, or in different blends. Coffee can be made espresso or cappuccino. Each variety of coffee can be caffeinated or not, be provided with extra milk (latté) or not, or be added with extra sugar or low caloric sweeteners or not. For a small dinner party, a server might remember which diner ordered what beverage. However, more often, and especially in the case of large dinner parties, the beverage order is not correctly initially delivered to all parties, because the server cannot remember who ordered which beverage and/or because many of the beverages look alike. This problem is exacerbated when any one diner orders a refill. The server almost always has to ask the diner to once again identify the previously ordered beverage.

Coffee, tea and like beverages are also commonly served by take-out restaurants without coasters, for example, in paper or foam cups. Here again, similar looking beverages cannot be readily visually distinguished.

### SUMMARY OF THE INVENTION

### OBJECTS OF THE INVENTION

Accordingly, it is a general object of this invention is to reliably visually identify the contents of a container.

Another object of this invention is to identify the type of beverage served in a container.

Still another object of this invention is to enable a beverage order to be correctly delivered.

Yet another object of this invention is to enable a server to correctly execute a beverage order, as well as refills without having to ask a diner to identify the previously ordered beverage.

### FEATURES OF THE INVENTION

In keeping with these objects, one aspect of this invention, briefly stated, resides in an identifier for identifying contents of a container. In a preferred embodiment, the identifier is a coaster which comprises a mat for placement underneath the container. The mat has a plurality of regions that are visually distinguished from one another. The visually distinguished regions identify a corresponding plurality of different contents that could be contained in the container. One of these regions of the mat is aligned with a feature of the container in order to visually indicate the contents of the container. For example, the feature of the container may be a handle which is positioned to overlie a selected region of the mat. Another feature of the container may be an arrow or like indicator which is positioned to point to a selected region of the mat.

In a preferred embodiment, the container is a cup having a handle, and the contents are coffee or tea, which, as noted above, can be ordered in a myriad of different types. The server positions the coaster between the cup and a saucer, and aligns the one mat region (which correctly identifies the beverage) with the handle. Thus, the server knows at a glance the identity of the contents of the container in order to correctly execute the order and any subsequent refills, and concomitantly, the diner knows at a glance the identity of the beverage being served.

The coaster is advantageously made of a material that absorbs liquid, and has a generally circular shape. The visually distinguished regions are preferably formed as sectors, each bearing text that identifies the various beverages that one can order.

It is further desirable if a region of the mat is provided with indicia, such as text and/or a logo, identifying a sponsor, particularly a credit card company. Coffee and tea are generally served at the conclusion of a meal prior to payment. Many diners typically have a plurality of credit cards in their possession which can be used for payment. The presence of the name of a particular credit card company on the coaster serves as an advertising reminder, or at least a subliminal suggestion, as to which credit card should be used. Indeed, if the name of the credit card company is in the center of the coaster, then the name is alternatively hidden and exposed each time the diner sips from the lifted cup. In effect, each sip reveals the name of the credit card company and reinforces the subliminal suggestion or reminder that the advertised credit card should be selected for payment.

In another preferred embodiment, the identifier is not a coaster, but is an annular sleeve surrounding the container. The visually distinguished regions are provided on the sleeve or the container. The indicator is likewise provided on the container or the sleeve. The sleeve is rotated until the indicator correctly points to the region that correctly identifies the contents of the container.

In still another embodiment, no alignment between a container and an identifier is required. Instead, the identifier is marked to identify the contents of the container. For example, in the case of a coaster having visually distinguished regions as described above, a portion of a selected visually distinguished region can be folded over, thereby indicating the contents of a container placed on the coaster.

The novel features which are considered as characteristic of the invention are set forth herein. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view on a reduced scale of a coaster placed underneath a cup having a handle in accordance with one embodiment of this invention;

FIG. 2 is a top plan view of the coaster of FIG. 1, with the cup and its handle shown in phantom lines;

FIG. 3 is a perspective view of the coaster of FIG. 1 placed underneath a cup without a handle in accordance with another embodiment of this invention;

FIG. 4 is a perspective view of an annular sleeve surrounding a cup in accordance with yet another embodiment of this invention;

FIG. 5 is a perspective view of an annular sleeve surrounding a cup in accordance with an additional embodiment of this invention; and

FIG. 6 is a top plan view of a coaster in accordance with yet another embodiment of this invention.

### DETAILED DESCRIPTION OF THE PREFERRED EMBODIMENTS

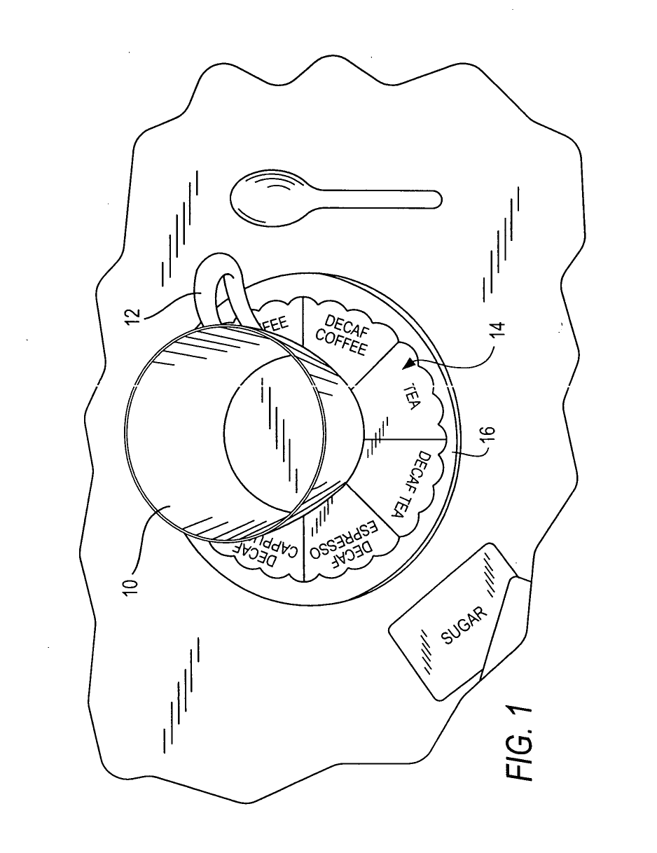

Referring to FIG. 1, a beverage such as tea or coffee is served in a cup 10 having a handle 12. A coaster 14 is placed underneath the cup 10. Preferably, a saucer 16 is placed underneath the coaster to support the cup.

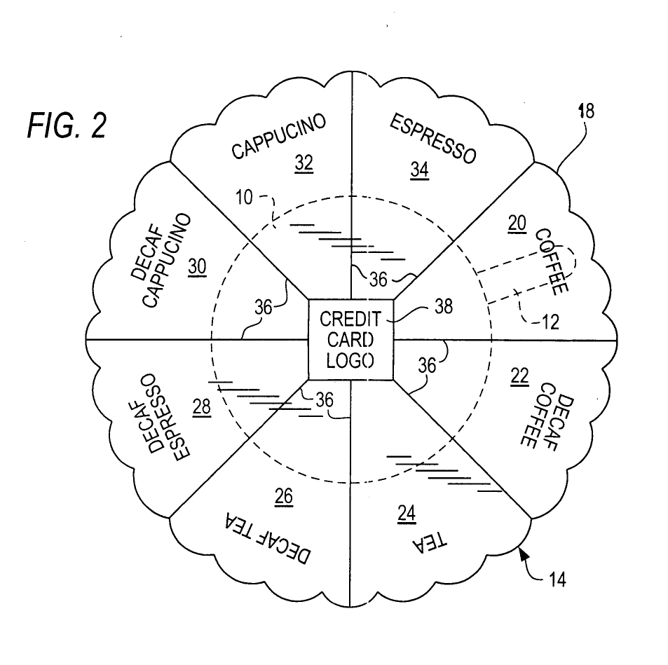

In accordance with this embodiment of the invention, the coaster 14 has a plurality of mat regions 20, 22, 24, 26, 28, 30, 32, 34 visually distinguished from one another. As shown in FIG. 2, the coaster 14 has a generally circular shape, and each mat region has a sector shape. Advantageously, an outer peripheral edge 18 of the coaster is scalloped. The coaster can be constituted of any material, but especially a fluid-absorbent material, such as paper, fabric, linen, lace, felt, foam and the like.

Each mat region has indicia identifying the types of beverages that could be contained in the cup. As illustrated, the indicia include, but are not limited to, the following legends: coffee, decaffeinated coffee, tea, decaffeinated tea, decaffeinated espresso, decaffeinated cappuccino, cappuccino, and espresso.

FIG. 2 depicts that the mat regions are separated by dividing lines 36 extending radially from the center of the coaster to the outer edge 18. These dividing lines can be printed solid lines as shown, or interrupted lines. The lines need not be printed, but can be solid or interrupted crease lines. Lines are not even necessary if, in accordance with a modification, each sector is differently colored, or embossed.

No matter how the mat regions are visually distinguished from one another, a waiter or waitress orients the handle 12 of the cup to overlie the mat region that correctly identifies the contents of the cup. This is demonstrated by phantom lines in FIG. 2. The server and the person being served each know, at a glance, whether the beverage that was ordered is, in fact, the one being served. The server can serve a refill without resorting to asking the served person just what beverage was previously ordered.

A central region 38 of the mat is advantageously printed with indicia bearing the name and/or logo of a sponsor, e.g., a credit card company. This central region 38 is hidden from view when the cup is on the coaster, but is revealed each time the cup is lifted therefrom.

The exposure of the name of the credit card company serves as an advertisement and a timely suggestion as to which credit card the diner should use to effect payment. This advertisement is all the more effective because it is revealed to the diner just prior to the time when payment is ordinarily made.

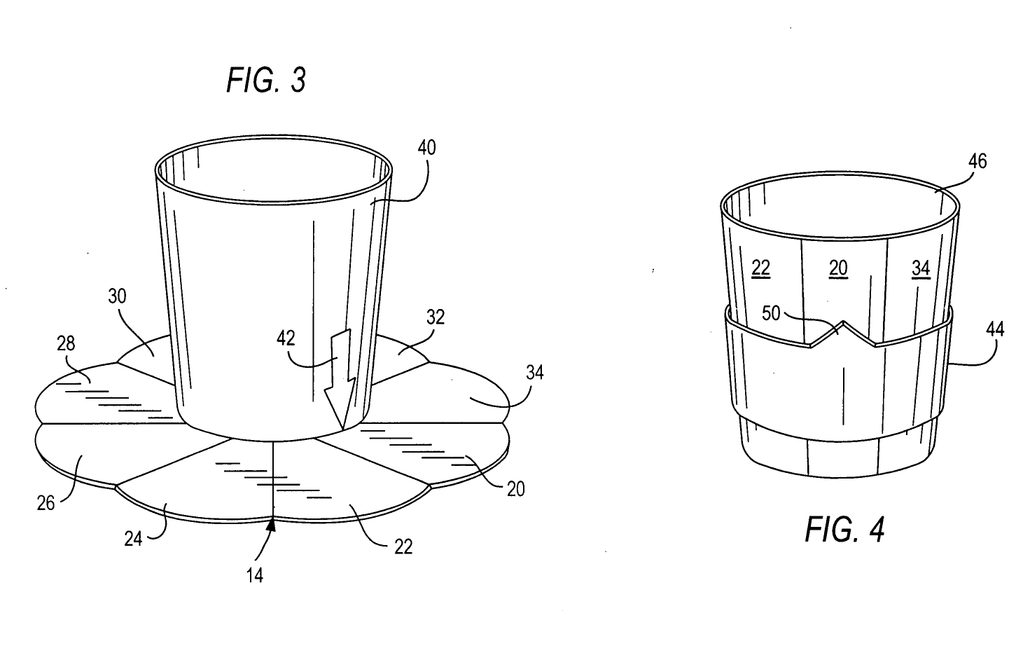

FIG. 3 depicts the coaster 14 placed underneath a cup 40 having no handle. Instead, an indicator 42, in this case, an arrow, is printed or embossed on the cup. A beverage in the cup 40 is identified by aligning the indicator 42 with a selected one of the visually distinguished mat regions on the coaster.

Instead of employing a coaster, an annular sleeve 44, as shown in FIG. 4, is mounted on and surrounds a cup 46. The visually distinguished regions are applied to the cup 46, rather than on the coaster as described above. An indicator 50, in this case, a V-shaped extension, is integral with the sleeve and its apex points to a selected one of the visually distinguished regions on the cup 46.

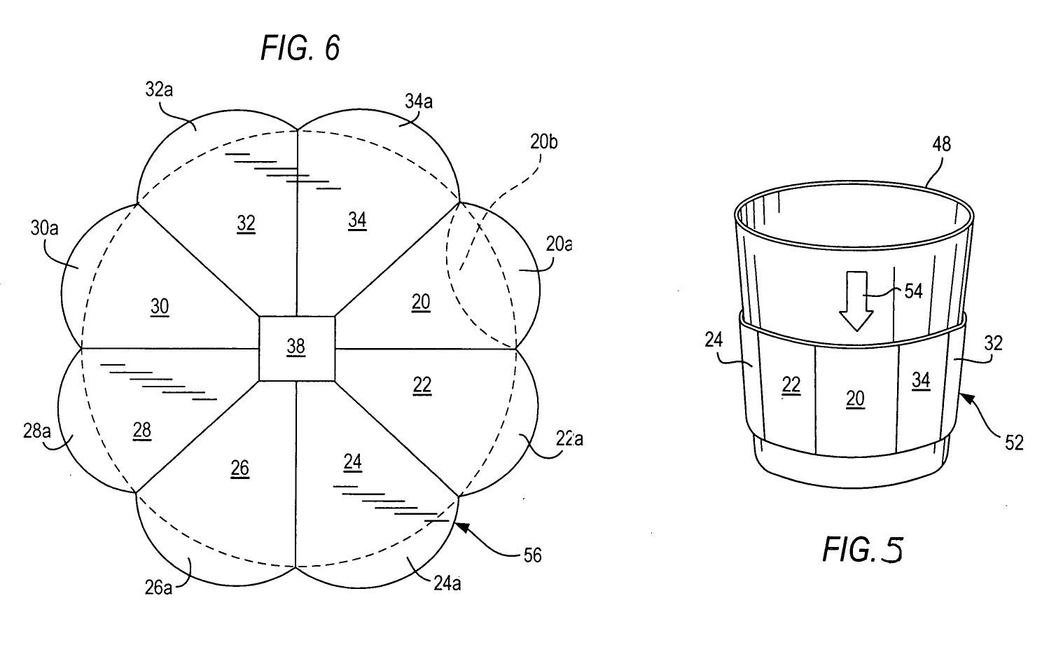

FIG. 5 depicts another annular sleeve 52 mounted on and surrounding a cup 48. In this embodiment, the visually distinguished regions are applied on the sleeve 52, and an indicator 54, similar to the indicator 42 of FIG. 3, is applied on the cup 48. Again, alignment between the indicator 54 and one of the visually distinguished regions identifies the contents of the cup 48.

In the embodiments of FIGS. 3-5, the cup is preferably constituted of foam or paper, and has no outwardly extending handle. The sleeves 44, 52 of FIGS. 4-5 not only serve to assist in identifying the contents of their associated containers, but also serve as thermally insulating sleeves to help protect a person's fingers from being subjected to excessive temperatures. Thus, the sleeves are made of any material, but preferably a corrugated board. Indicia bearing a sponsor's name and/or logo can be printed anywhere on the sleeve or the cup.

FIG. 6 depicts another coaster 56 analogous to the coaster 14 of FIG. 2, except that its outer edge has a series of curved projections 20a, 22a, 24a, 26a, 28a, 30a, 32a and 34a respectively associated with the visually distinguished regions 20, 22, 24, 26, 28, 30, 32 and 34. When placed underneath a cup, one of the projections, for example, projection 20a, is folded over onto its visually distinguished region 20 to the position shown by reference character 20b. The folded projection serves as the indicator to identify the contents of a container placed on the coaster 56. The container may or may not have a handle, and may or may not be supported by a saucer.

It will be understood that each of the elements described above, or two or more together, also may find a useful application in other types of constructions differing from the types described above.

While the invention has been illustrated and described as embodied in a coaster or a sleeve, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

I claim:

1. An identifier for visually identifying contents of a container, comprising:
a) a plurality of identifier regions visually distinguished from one another and respectively identifying a corresponding plurality of different contents for containment in the container; and
b) means for manually selecting one of the identifier regions to identify the contents of the container.

2. The identifier of claim 1, wherein the selecting means includes a coaster on which the identifier regions are located.

3. The identifier of claim 2, wherein the coaster has a central region for supporting the container in an overlaid position, and wherein the identifier regions extend away from the central region and are visible in the overlaid position.

4. The identifier of claim 3, wherein the identifier regions are separated by radial boundary lines extending radially of the central region.

5. The identifier of claim 1, wherein each identifier region bears indicia identifying the different contents for the container.

6. The identifier of claim 3, wherein the central region bears indicia identifying a payment provider, the indicia of the central region being concealed by the container in the overlaid position, and being exposed to view when the container is not in the overlaid position.

7. The identifier of claim 2, wherein the identifier regions bear indicia identifying different fluid contents for the container, and wherein the coaster is constituted of a fluid absorbing material.

8. The identifier of claim 2, wherein the coaster is a planar mat having a generally circular shape with a scalloped peripheral edge.

9. The identifier of claim 1, wherein the selecting means is operative for aligning the selected one of the identifier regions with an element of the container.

10. The identifier of claim 9, wherein the element is a handle for the container.

11. The identifier of claim 9, wherein the element is an indicator provided on a sidewall of the container.

12. The identifier of claim 1, wherein the selecting means includes an annular sleeve surrounding, and movable relative to, the container.

13. The identifier of claim 12, wherein the identifier regions are located on the container, and wherein the selecting means includes a pointer on the sleeve, the pointer being aligned with the selected one of the identifier regions.

14. The identifier of claim 12, wherein the identifier regions are located on the sleeve, and wherein the selecting means includes a pointer on the container, the pointer being aligned with the selected one of the identifier regions.

15. The identifier of claim 12, wherein the sleeve is constituted of a thermally insulating material.

16. The identifier of claim 3, wherein the identifier regions have bendable outer portions, one of the outer portions of the selected one of the identifier regions being bent to identify the contents of the container.

17. The identifier of claim 1, wherein the identifier regions identify different beverages for filling the container.
